(19) United States
(12) Patent Application Publication
(10) Pub. No.: US 2018/0230853 A1
(43) Pub. Date: Aug. 16, 2018

(54) METHOD FOR LIMITING THE CORE ENGINE SPEED OF A GAS TURBINE ENGINE DURING ICING CONDITIONS

(71) Applicant: General Electric Company, Schenectady, NY (US)

(72) Inventors: Steven James Jastrzembowski, Cincinnati, OH (US); Michael R. Stover, West Chester, OH (US); Bobby Shields, Montgomery, OH (US); Thomas Charles Swager, Maineville, OH (US)

(21) Appl. No.: 15/333,215

(22) Filed: Oct. 25, 2016

(51) Int. Cl. F01D 25/02; F02C 9/28

(52) U.S. Cl. CPC F01D 25/02; F02C 9/28; F05D 2220/323; F05D 2270/303; F05D 2270/304; F05D 2270/02

(57) ABSTRACT

A method for controlling a gas turbine engine is provided. The method includes determining if a potential icing condition exists, for example, by determining whether a corrected fan speed percentage is below a predetermined fan speed threshold. If a potential icing condition exists, a fuel regulator may operate according to a first control algorithm by restricting the flow of fuel to the engine if the corrected core speed percentage of the core engine exceeds a predetermined core speed threshold. If a potential icing condition does not exist such that the fan section and core engine of the gas turbine engine are operating normally, the fuel regulator may operating according to a second control algorithm that does not include such a hard compressor speed limit.

### FIELD OF THE INVENTION

The present subject matter relates generally to gas turbine engines, and more specifically, to a method of regulating the core speed of a gas turbine engine to improve operability during icing conditions.

### BACKGROUND OF THE INVENTION

A gas turbine engine generally includes a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

Conventional gas turbine engines include fuel flow regulators and control systems to properly regulate fuel flow into the combustion section of the gas turbine engine during various operating conditions. For example, during icing conditions, the fan and low pressure compressor may be slowed due to the accumulation of ice, and thus may fail to provide sufficiently pressurized air to the high pressure compressor. As a result, the fuel regulator may be configured to increase the core engine speed and the fan speed by providing additional fuel to the combustion section. Under certain conditions, accelerating the engine in this manner raises the core temperature and increases rotor speeds sufficiently to cause the shedding of accumulated ice.

However, such control systems may have difficultly regulating fuel flow during extreme icing conditions. In such situations, the fan and low pressure compressor section may “hang up” or slow down, e.g., due to blockages of ice, while the core engine continues to accelerate.

Accordingly, a method for regulating the core engine speed of a gas turbine engine during icing conditions would be useful.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a method for controlling a gas turbine engine is provided. The gas turbine engine includes a fan, a compressor section, a combustion section, and a turbine section. The method includes providing a flow of fuel to the combustion section of the gas turbine engine and determining an icing condition exists. The method further includes determining a corrected core speed percentage of the gas turbine engine exceeds a predetermined core speed threshold and reducing the flow of fuel to the combustion section of the gas turbine engine in response to determining the icing condition exists and the corrected core speed percentage exceeds the predetermined core speed threshold.

In another exemplary embodiment of the present disclosure, a method for controlling a gas turbine engine is provided. The gas turbine engine includes a fan, a compressor section, a combustion section, and a turbine section. The method includes providing a flow of fuel to the combustion section of the gas turbine engine, determining a corrected fan speed percentage, and determining a corrected core speed percentage. The method further includes regulating the flow of fuel to the combustion section under a first operating algorithm if the corrected fan speed percentage is below a predetermined fan speed threshold, the first operating algorithm including limiting the flow of fuel to the combustion section of the gas turbine engine to maintain the corrected core speed percentage below a predetermined core speed threshold. The method also includes regulating the flow of fuel to the combustion section under a second operating algorithm if the corrected fan speed percentage exceeds the predetermined fan speed threshold.

In yet another exemplary embodiment of the present disclosure, a computer-implemented method of controlling fuel flow is provided. The method includes determining, by one or more computing devices, a flowrate of fuel to a combustion section of a gas turbine engine. The method further includes determining that an icing condition of the gas turbine engine exists and that a corrected core speed percentage of the gas turbine engine exceeds a predetermined core speed threshold. The method also includes reducing, by the one or more computing devices, the flowrate of fuel to the combustion section of the gas turbine engine in response to determining the icing conditions exists and the corrected core speed percentage exceeds the predetermined core speed threshold.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a schematic cross-sectional view of an exemplary gas turbine engine according to various embodiments of the present subject matter.

FIG. 2 provides a schematic representation of the exemplary gas turbine engine of FIG. 1 including a control system according to an exemplary embodiment of the present subject matter.

FIG. 3 provides a flow diagram of a method of operating the exemplary gas turbine engine of FIG. 1 during icing conditions according to an exemplary embodiment of the present subject matter.

FIG. 4 provides a plot illustrating the implementation of a fuel regulating algorithm during a severe icing event according to an exemplary embodiment of the present subject matter.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

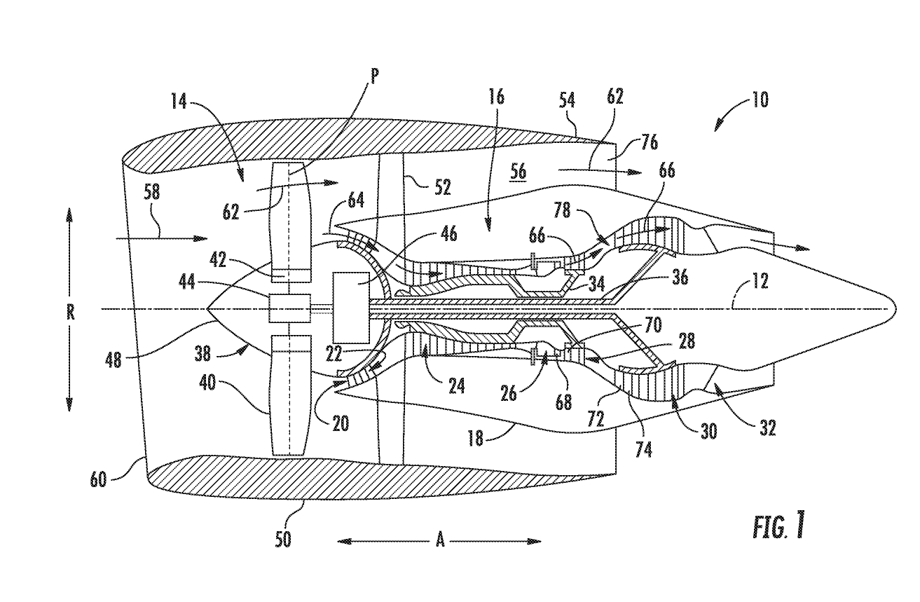

Referring now to the drawings, wherein identical numerals indicate the same elements throughout the figures, FIG. 1 is a schematic cross-sectional view of a turbomachine in accordance with an exemplary embodiment of the present disclosure. More particularly, for the embodiment of FIG. 1, the turbomachine is configured as a gas turbine engine, or rather as a high-bypass turbofan jet engine 10, referred to herein as “turbofan engine 10.” As shown in FIG. 1, the turbofan engine 10 defines an axial direction A (extending parallel to a longitudinal centerline 12 provided for reference), a radial direction R, and a circumferential direction (not shown) extending about the longitudinal centerline 12. In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases and the core turbine engine 16 includes, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. Accordingly, the LP shaft 36 and HP shaft 34 are each rotary components, rotating about the axial direction A during operation of the turbofan engine 10.

Referring still to the embodiment of FIG. 1, the fan section 14 includes a variable pitch fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40 in unison. The fan blades 40, disk 42, and pitch change mechanism 44 are together rotatable about the longitudinal axis 12 by LP shaft 36 across a power gear box 46. The power gear box 46 includes a plurality of gears for adjusting the rotational speed of the fan 38 relative to the LP shaft 36 to a more efficient rotational fan speed. More particularly, the fan section includes a fan shaft rotatable by the LP shaft 36 across the power gearbox 46. Accordingly, the fan shaft may also be considered a rotary component, and is similarly supported by one or more bearings. It should be appreciated that according to alternative embodiments, fan blades 40 may instead have a fixed pitch.

Referring still to the exemplary embodiment of FIG. 1, the disk 42 is covered by a rotatable front hub 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. The exemplary nacelle 50 is supported relative to the core turbine engine 16 by a plurality of circumferentially-spaced outlet guide vanes 52. Moreover, a downstream section 54 of the nacelle 50 extends over an outer portion of the core turbine engine 16 so as to define a bypass airflow passage 56 therebetween.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is increased in pressure and is directed or routed into the bypass airflow passage 56 and a second portion of the air 58 as indicated by arrow 64 is increased in pressure and is directed or routed into the core air flowpath, or more specifically into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the core turbine engine 16 to provide propulsive thrust. Simultaneously, the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

It should be appreciated, however, that the exemplary turbofan engine 10 depicted in FIG. 1 is provided by way of example only, and that in other exemplary embodiments, the turbofan engine 10 may have any other suitable configuration. It should also be appreciated, that in still other exemplary embodiments, aspects of the present disclosure may be incorporated into any other suitable gas turbine engine. For example, in other exemplary embodiments, aspects of the present disclosure may be incorporated into, e.g., a turboprop engine, a turboshaft engine, or a turbojet engine. Further, in still other embodiments, aspects of the present disclosure may be incorporated into any other suitable turbomachine, including, without limitation, a steam turbine, a centrifugal compressor, and/or a turbocharger.

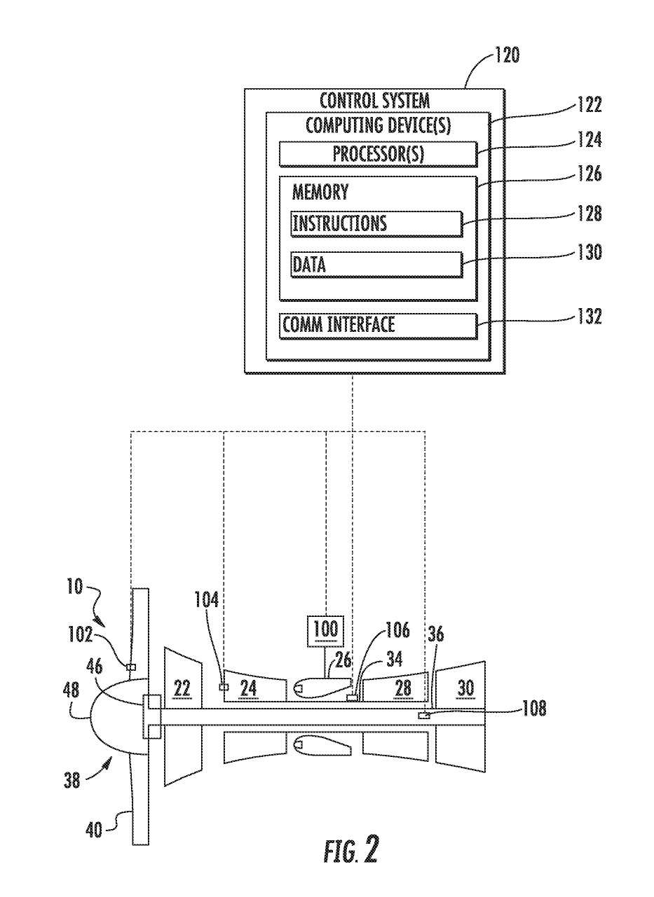

Referring now to FIG. 2, a schematic representation of a gas turbine engine, such as turbofan engine 10, is provided. As illustrated, turbofan engine 10 includes a fuel regulator 100. Fuel regulator 100 is configured for delivering fuel to combustion section 26, where the fuel is mixed with the compressed air and burned, as discussed above. As described in more detail below, fuel regulator 100 may generally provide fuel to the combustion section 26 according to one or more control algorithms, depending on the application and conditions. For example, fuel regulation may depend on a variety of system parameters, both internal to turbofan engine 10 and external conditions such as ambient air speed, temperature, and pressure. In addition, fuel regulation may depend on control inputs, e.g., from a user or pilot.

Notably, turbofan engine 10 includes many sensors throughout turbofan engine 10 and the aircraft to which it is mounted for monitoring these various parameters and providing feedback for use in control algorithms. For example, as illustrated in FIG. 2, turbofan engine 10 may have a fan inlet temperature sensor 102, a compressor inlet temperature sensor 104, a high pressure spool shaft speed sensor 106, and a low pressure spool shaft speed sensor 108. It should be appreciated that the sensors described above are only exemplary sensors and that turbofan engine 10 may have any suitable number and type of sensors as needed for operation.

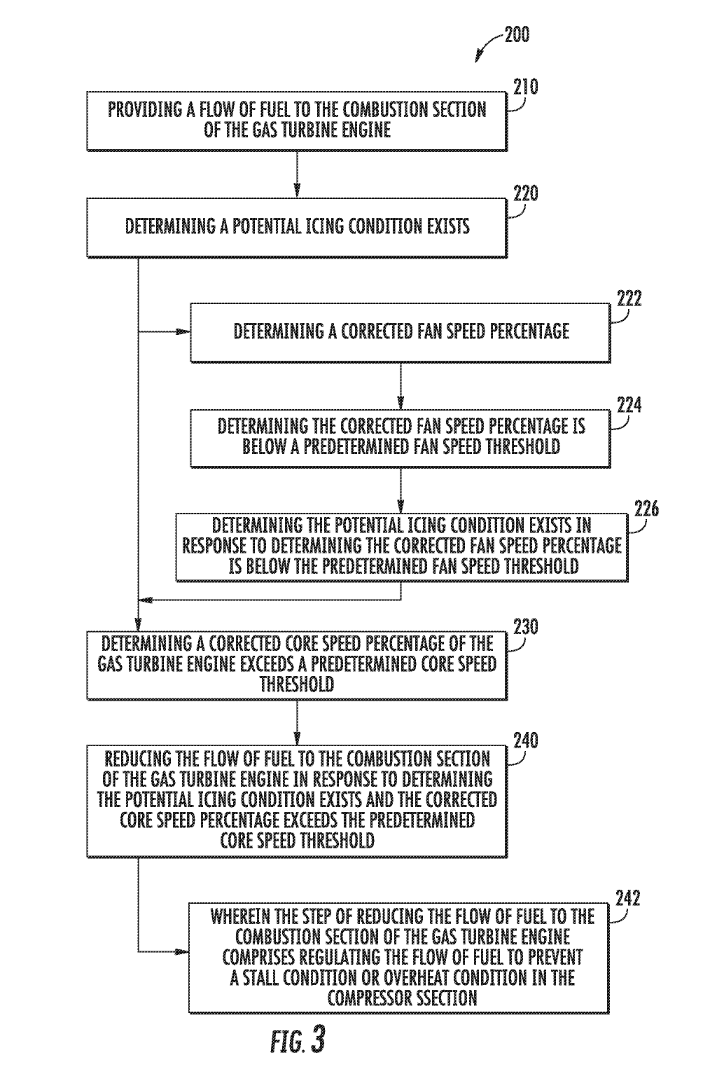

Referring still to FIG. 2, turbofan engine 10 further includes a control system 120. As shown, the control system 120 can include one or more computing device(s) 122. The computing device(s) 122 may be configured to execute one or more methods in accordance with exemplary aspects of the present disclosure (such as method described below with reference to FIG. 3). The computing device(s) 122 can include one or more processor(s) 124 and one or more memory device(s) 126. The one or more processor(s) 124 can include any suitable processing device, such as a microprocessor, microcontroller, integrated circuit, logic device, or other suitable processing device. The one or more memory device(s) 126 can include one or more computer-readable media, including, but not limited to, non-transitory computer-readable media, RAM, ROM, hard drives, flash drives, or other memory devices.

The one or more memory device(s) 126 can store information accessible by the one or more processor(s) 124, including computer-readable instructions 128 that can be executed by the one or more processor(s) 124. The instructions 128 can be any set of instructions that when executed by the one or more processor(s) 124, cause the one or more processor(s) 124 to perform operations. The instructions 128 can be software written in any suitable programming language or can be implemented in hardware. In some embodiments, the instructions 128 can be executed by the one or more processor(s) 124 to cause the one or more processor(s) 124 to perform operations, such as the operations for regulating fuel flow, as described herein, and/or any other operations or functions of the one or more computing device(s) 122. Additionally, and/or alternatively, the instructions 128 can be executed in logically and/or virtually separate threads on processor 124. The memory device(s) 126 can further store data 130 that can be accessed by the processors 124.

The computing device(s) 122 can also include a communications interface 132 used to communicate, for example, with the other components of turbofan engine 10. The communications interface 132 can include any suitable components for interfacing with one more communications network(s), including for example, transmitters, receivers, ports, controllers, antennas, or other suitable components. Control system 120 may also be communication (e.g., via communications interface 132) with the various sensors, such as sensors 102, 104, 106, 108 described above, and may selectively operating turbofan engine 10 in response to user input and feedback from these sensors.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Now that the construction and configuration of turbofan engine 10 have been presented, an exemplary method 200 of operating turbofan engine 10 (e.g., by regulating fuel regulator 100) will be described. Method 200 is described herein as operating turbofan engine 10. However, it should be appreciated that aspects of method 200 may be used to operate any gas turbine engine, and the use of turbofan engine 10 for explanatory purposes is not intended to limit the scope of the present subject matter.

Referring now specifically to FIG. 3, method 200 includes, at step 210, providing a flow of fuel to the combustion section of the gas turbine engine, e.g., via fuel regulator 100. At step 220, method 200 includes determining a potential icing condition exists. According to one exemplary embodiment, a potential icing condition may be detected by monitoring a corrected fan speed percentage. More specifically, at step 222, method 200 includes determining a corrected fan speed percentage, and step 224 includes determining the corrected fan speed percentage is below a predetermined fan speed threshold. Step 226 includes determining the potential icing condition exists in response to determining at 224 the corrected fan speed percentage is below the predetermined fan speed threshold.

Therefore, if the corrected fan speed percentage is below a predetermined fan speed threshold, method 200 may determine at step 220 that a potential icing condition exists. In this regard, a corrected fan speed percentage below a predetermined fan speed threshold may indicate that ice has accumulated on the fan or LP compressor and is causing them to “hang up” or rotate slower than expected. It should be appreciated that other methods of detecting potential icing conditions are possible and within the scope of the present subject matter. For example, according to some embodiments, a variety of sensors may be used to detect the presence of moisture and the build-up of ice as it accumulates.

Method 200 further includes, at step 230, determining a corrected core speed percentage of the gas turbine engine exceeds a predetermined core speed threshold. Corrected shaft speeds, as used herein, generally refer to the rotational speed of a particular spool (e.g., HP spool 34 or LP spool 36) corrected to ambient conditions and expressed as a percentage of a nominal value. The nominal value may be any suitable reference value, such as the “full thrust” rotational spool speed, or a maximum rated rotational speed of the spool. For example, corrected core speed N_{2K}, as used herein, refers to the speed of the core engine rotor (e.g., the rotational speed of the HP spool 34) corrected to a compressor inlet temperature (e.g., as measured by compressor inlet temperature sensor 104). More specifically, corrected core speed N_{2K} may be calculated by dividing the rotational speed of the HP spool 34 by the square root of the compressor inlet temperature. Similarly, corrected fan speed N_{1K}, as used herein, refers to the speed of fan 38 (e.g., the rotational speed of the LP spool 36) corrected to a fan inlet temperature (e.g., as measured by fan inlet temperature sensor 102). More specifically, corrected fan speed N_{1K} may be calculated by dividing the rotational speed of the LP spool 36 by the square root of the fan inlet temperature. It should be appreciated that other methods for determining corrected speed percentages are possible and within the scope of the present subject matter.

Method 200 further includes, at step 240, reducing the flow of fuel to the combustion section of the gas turbine engine in response to determining the potential icing condition exists and the corrected core speed percentage exceeds the predetermined core speed threshold. As explained below, this hard limit on corrected core speed percentage during severe icing conditions is intended to prevent operability issues with the gas turbine engine. As used herein, “operability issues” may refer to any adverse operating condition of a gas turbine engine resulting from a compressor running at higher than desired speeds. For example, operability issues may include core engine overheating, compressor stall, etc. As such, the predetermined core speed threshold may be selected to correspond, e.g., to a maximum temperature threshold or another operability limit of the gas turbine engine to prevent the occurrence of operability issues.

According to one exemplary embodiment, method 200 further includes, at step 242, determining, subsequent to determining the potential icing condition exists, that the icing condition does not exist and then operating the gas turbine engine such that the corrected core speed percentage exceeds the predetermined core speed threshold in response to determining that the icing condition does not exist. As explained below, this soft limit on corrected core speed percentage during dry, or no-ice, conditions is intended to apply during normal operation of turbofan engine 10.

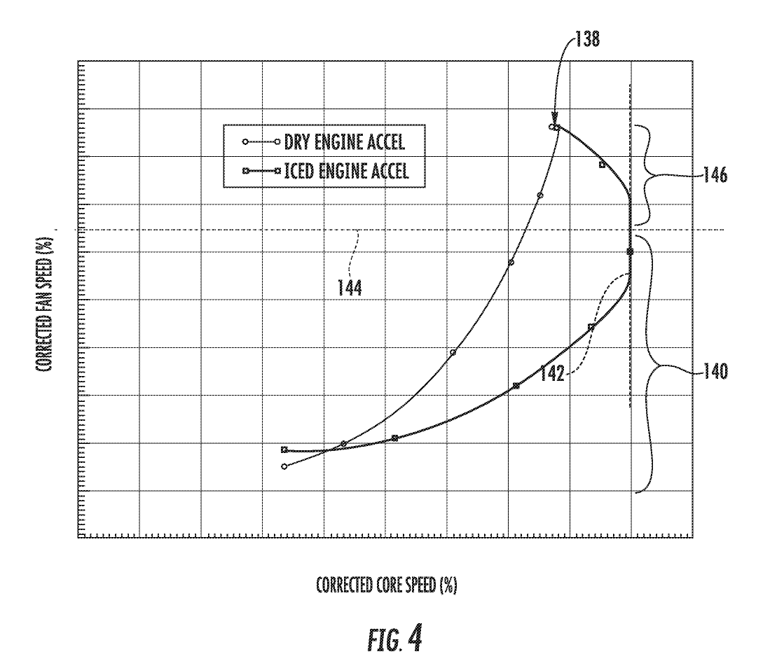

As an example, using method 200 described above, turbofan engine 10, and more particularly, fuel regulator 100, may operate in two different modes depending on whether icing conditions exist. For example, if the corrected fan speed percentage is below a predetermined fan speed threshold (e.g., the N_{1K} limit 144 in FIG. 4), this may indicate that potential icing conditions exist. Under such conditions, fuel regulator 100 may regulate fuel according to a first operating algorithm optimized for icing conditions.

The first operating algorithm may include limiting the flow of fuel to combustion section 26 of turbofan engine 10 to maintain the corrected core speed percentage below a predetermined core speed threshold (e.g., the N_{2K} limit 142 in FIG. 4). Such predetermined core speed threshold may be selected to prevent runaway or uncontrolled acceleration of the core engine when fan 38 is hung up or slowed down by ice accumulation. In this regard, the first operating algorithm is a “hard” control algorithm configured for preventing uncontrolled acceleration of turbofan engine 10 in circumstances where fan 38 speeds are too low to support operation of turbofan engine 10, e.g., due to ice accumulation.

By contrast, fuel regulator 100 may regulate fuel according to a second operating algorithm when potential icing conditions do not exist. Continuing the above example, if the corrected fan speed percentage exceeds a predetermined fan speed threshold (e.g., the N_{1K} limit 144 in FIG. 4), this may indicate that fan 38 is rotating normally and is providing sufficient air to support the operation of HP compressor 24 Under such conditions, fuel regulator 100 may regulate fuel according to the second operating algorithm optimized for normal operating conditions.

The second operating algorithm may attempt to drive the corrected core speed percentage and the corrected fan speed percentage to a desired operating point (e.g., as indicated by reference numeral 138). Notably, however, the second operating algorithm may also allow the corrected core speed percentage to exceed the predetermined core speed threshold (e.g., the N_{2K} limit 142 in FIG. 4). In this regard, the second operating algorithm is a “soft” control algorithm configured for accelerating turbofan engine 10 to desired fan and core engine set points while preventing a stall condition in the compressor section. During the soft limit second operating algorithm, fuel flow is limited in a manner that turbofan engine 10 can accelerate under all conditions, but fuel regulator 100 is configured to ensure that engine reaches the desired operating point 138.

Referring now to FIG. 4, a plot of corrected fan speed percentage (N_{1K}) versus corrected core speed percentage (N_{2K}) for a gas turbine engine operating according to aspects of the present subject matter is provided. For example, using turbofan engine 10 as an example, corrected fan speed percentage N_{1K} of fan 38 is plotted versus corrected core speed percentage N_{2K} of the HP spool 34 during dry and icing conditions.

FIG. 4 illustrates at least two different operating regions. As explained above, lower corrected fan speed percentages N_{1K} may indicate a potential that ice has accumulated on fan 38 or LP compressor 22. As a result, it may be desirable to operate turbofan engine 10 according to a different control algorithm as compared to dry conditions, e.g., when it is unlikely that moisture will collect and freeze on components within turbofan engine 10. This performance of turbofan engine 10 operating according to this first operating algorithm is illustrated by the first operating region (indicated by reference numeral 140) in FIG. 4. First operating region 140 corresponds to a “hard limit” operation (as regulated according to method 200). As illustrated above, the hard limit (indicated by reference numeral 142) may be set at any suitable corrected core speed percentage N_{2K}.

The corrected fan speed N_{1K} limit 144 and the corrected core speed N_{2K} limit 142 may be any suitable percentages or may be selected to correspond to any particular operating condition of turbofan engine 10. For example, the corrected core speed N_{2K} limit 142 may be selected to correspond to a region of turbofan engine operation 10 where operability issues are likely to arise. For example, the corrected core speed N_{2K} limit 142 may be selected to prevent the compressor running at speeds where stall or overheating may occur. It should be appreciated that the selected percentage may vary depending on the application, the type of engine, the operating environment, etc. For example, according to an exemplary embodiment, the hard N_{2K} limit 142 may be set at a corrected core speed N_{2K} of between 100% and 125%, or between 90% and 150%.

While operating in the first operating region 140, the core engine may be maintained at this speed until the iced portions of turbofan engine 10 are shed, at which point the fan speed will increase. Therefore, until the corrected fan speed N_{1K} reaches a predetermined threshold (e.g., the N_{1K} limit 144 described below), fuel regulator 100 restricts the flow of fuel to combustion section 26 to prevent the corrected core speed percentage from exceeding the corrected core speed N_{2K} limit 142.

The second operating region (indicated by reference numeral 146) corresponds to a soft limit operating region. The soft limit operating region is initiated after the fan speed increases past the predetermined fan speed threshold (i.e., the N_{1K} limit 144). According to the example above, the N_{1K} limit 144 is set at specific percentage. However, it should be appreciated that other predetermined fan speed thresholds (N_{1K} limit 144) may be selected according to alternative embodiments. For example, the predetermined fan speed threshold (N_{1K} limit 144) may be selected to correspond to the time when sufficient ice has been shed from fan 38 and LP compressor 22 to ensure proper fan 38 operation with no hang-ups. Thus, according to an exemplary embodiment, the soft N_{1K} limit 144 may be set at a corrected fan speed percentage N_{1K} of between 50% and 100%, or between 65% and 85%.

As explained above, during certain operating conditions and environments, the flow of air through fan 38 and through the booster or LP compressor 22 may be restricted, e.g., due to ice accumulation. As a result, the HP compressor 24 may be starved of sufficient oxygen flow and may ramp up speed to compensate, thereby trying to increase the speed of fan 38 and LP compressor 22 to increase airflow. Notably, during accelerations in icing conditions resulting in a severely iced and blocked booster, fan 38 can hang up while the core engine continues to accelerate into operating regions that may result in overheating, HP compressor 24 stall, or other operability issues. Aspects of method 200 described above are directed at operating turbofan engine 10 during such scenarios by providing a hard limit to prevent compressor stall and core engine overheating. Accordingly, operating a gas turbine engine in accordance with one or more exemplary aspects of the present disclosure has a technical effect of allowing the engine to operate at this hard limit until the ice built-up ice is shed, at which point fan 38 is able to accelerate to the desired power setting and engine operation continues as normal.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for controlling a gas turbine engine, the gas turbine engine comprising a fan, a compressor section, a combustion section, and a turbine section, the method comprising:
providing a flow of fuel to the combustion section of the gas turbine engine;
determining a potential icing condition exists;
determining a corrected core speed percentage of the gas turbine engine exceeds a predetermined core speed threshold; and
reducing the flow of fuel to the combustion section of the gas turbine engine in response to determining the potential icing condition exists and the corrected core speed percentage exceeds the predetermined core speed threshold.

2. The method of claim 1, wherein the predetermined core speed threshold corresponds to a maximum temperature threshold or operability limit of the compressor section.

3. The method of claim 1, wherein the step of determining the potential icing condition exists comprises:
determining a corrected fan speed percentage;
determining the corrected fan speed percentage is below a predetermined fan speed threshold; and
determining the potential icing condition exists in response to determining the corrected fan speed percentage is below the predetermined fan speed threshold.

4. The method of claim 3, wherein the predetermined fan speed threshold corresponds to a fan speed at which ice is typically shed from the fan.

5. The method of claim 1, wherein the step of reducing the flow of fuel to the combustion section of the gas turbine engine comprises regulating the flow of fuel to prevent a stall condition or an overheat condition in the compressor section.

6. The method of claim 3, further comprising:
determining, subsequent to determining the potential icing condition exists, that the icing condition does not exist; and
operating the gas turbine engine such that the corrected core speed percentage exceeds the predetermined core speed threshold in response to determining that the icing condition does not exist.

7. A computer-implemented method of controlling fuel flow to a combustion section of a gas turbine engine, the method comprising:
determining, by one or more computing devices, a flowrate of fuel to a combustion section of a gas turbine engine;
determining, by the one or more computing devices, that a potential icing condition of the gas turbine engine exists;
determining, by the one or more computing devices, that a corrected core speed percentage of the gas turbine engine exceeds a predetermined core speed threshold; and
reducing, by the one or more computing devices, the flowrate of fuel to the combustion section of the gas turbine engine in response to determining the potential icing conditions exists and the corrected core speed percentage exceeds the predetermined core speed threshold.

8. The computer-implemented method of claim 7, wherein the predetermined core speed threshold corresponds to a maximum temperature threshold or operability limit of the compressor section.

9. The computer-implemented method of claim 7, wherein the step of determining that a potential icing condition of the gas turbine engine exists comprises:
determining, by the one or more computing devices, that the potential icing condition exists in response to determining a corrected fan speed percentage is below a predetermined fan speed threshold.

10. The computer-implemented method of claim 9, wherein the predetermined fan speed threshold corresponds to a fan speed at which ice is typically shed from the fan.

11. The computer-implemented method of claim 7, wherein the step of reducing the flow of fuel to the combustion section of the gas turbine engine comprises regulating the flow of fuel to prevent a stall condition or an overheat condition in the compressor section.

12. The method of claim 7, further comprising:
determining, subsequent to determining the potential icing condition exists, that the icing condition does not exist; and
operating the gas turbine engine such that the corrected core speed percentage exceeds the predetermined core speed threshold in response to determining that the icing condition does not exist.

13. A computing system operable with a gas turbine engine, the computing system comprising:
one or more processors; and
one or more memory devices, the one or more memory devices storing computer-readable instructions that when executed by the one or more processors cause the one or more processors to perform operations, the operations comprising:
determining a potential icing condition of the gas turbine engine exists;
determining a corrected core speed percentage of the gas turbine engine exceeds a predetermined core speed threshold; and
reducing the flowrate of fuel to a combustion section of the gas turbine engine in response to determining the potential icing condition exists and the corrected core speed percentage exceeds the predetermined core speed threshold.

14. The computing system of claim 13, wherein the predetermined core speed threshold corresponds to a maximum temperature threshold or operability limit of the compressor section.

15. The computing system of claim 13, wherein determining the potential icing condition exists comprises:
determining a corrected fan speed percentage;
determining the corrected fan speed percentage is below a predetermined fan speed threshold; and
determining the potential icing condition exists in response to determining the corrected fan speed percentage is below the predetermined fan speed threshold.

16. The computing system of claim 13, wherein reducing the flow of fuel to the combustion section of the gas turbine engine comprises regulating the flow of fuel to prevent a stall condition or an overheat condition in the compressor section.

17. The computer-implemented method of claim 13, wherein the predetermined fan speed threshold corresponds to a fan speed at which ice is typically shed from the fan.
